(19) United States
(12) Patent Application Publication
(10) Pub. No.: US 2014/0357096 A1
(43) Pub. Date: Dec. 4, 2014

(54) RETENTION DEVICE FOR PLUGS

(71) Applicants: EDWARD Dean Gogel, Las Vegas, NV (US); ONED CO., LTD., Hualien County (TW)

(72) Inventors: CHIH-JU KUO, HUALIEN COUNTY (TW); EDWARD DEAN GOGEL, LAS VEGAS, NV (US)

(73) Assignee: ONED CO., LTD., Hualien County (TW)

(21) Appl. No.: 14/288,539

(22) Filed: May 28, 2014

(30) Foreign Application Priority Data
May 30, 2013 (TW) 102210080

(51) Int. Cl. H01R 13/62; H01R 43/26; H01R 13/639

(52) U.S. Cl. CPC H01R 13/6205; H01R 13/639; H01R 43/26
USPC 439/40; 439/299; 29/825

(57) ABSTRACT

Disclosed is a plug retention device consisting of a frame applied between the socket of an electronic device and it's plug. The frame decreases the annular gap present between the plug and socket, thereby improving retention of the plug within the socket and preventing accidental disconnection.

### FIELD OF THE INVENTION

The present invention relates to a plug and socket accessory device, in particular to a frame for improving retention of a plug within a socket.

### BACKGROUND OF THE INVENTION

In general, electronic devices haven socket provided for attaching an electrical power cable to an external electrical power supply. However, some electronic devices as shown in FIG. 7 are designed with the socket 5 internal dimensions greater than the plug 4 external dimensions, so that when the plug 4 is attached to the socket 5, an annular gap 51 is formed between the plug 4 and the socket 5. If a force is applied to the plug 4, the gap 51 will become a space that may loosen the plug 4, or cause the plug 4 to easily disconnect from the socket 5. In many cases this increases the likelihood of accidental disconnection and greatly inconveniences users of said devices.

Some electronic devices, such as a portable computer shown in FIG. 1, rely on an internal magnet to retain the plug 4 within the socket 5, such as described in U.S. Pat. No. 7,311,526. Devices using said magnetic retention method depend less on plug retention via friction and tend to have a larger annular gap 51 than traditional plugs and sockets. Magnetically retained plugs and sockets can be used to prevent electronic devices from sustaining damage when the attached power cord is inadvertently moved forcefully. Said decreased force necessary for disconnection may, however, increase the likelihood of accidental disconnection and lead to user frustration. Inventions referenced as prior art have tried to solve this problem by adding external cages, housings, or retainers. These solutions however are both inconvenient to the user and detract from the external appearance of said devices.

Furthermore, to reduce weight and increase portability, many electronic device housings are built from non-ferrous materials such as aluminum. Since these materials are not capable of becoming temporary or permanent magnets, devices using said magnetic plug retention method described in U.S. Pat. No. 7,311,526 primarily rely on the close proximity or direct contact between the magnet and plug for retention. This exacerbates the problem of accidental disconnection since the magnetic element is often located at the deepest point of the socket and the socket's inner peripheral wall is usually non-ferrous and non-magnetic. As illustrated in FIG. 7, movement of the plug within the socket can cause the plug to lose contact with the magnetic element inside the socket and easily disconnect.

The present invention describes an accessory frame that improves the plug and socket configuration to overcome the aforementioned problems.

### SUMMARY OF THE INVENTION

The present invention overcomes the shortcomings of the prior art by providing a retention device for plugs by introducing a frame that reduces the gap between the plug and the socket, so as to prevent the plug from inadvertently disconnecting from the socket.

In one embodiment, the retention device is removable and made of material attracted to a magnet. When used inside a magnetic connector such as described in U.S. Pat. No. 7,311,526, the retention device is itself retained by the magnetic element of said magnetic connector. Said device may become temporarily magnetic while in close proximity of said magnetic element, further enhancing retention of the said plug within said socket.

### PRIOR ART

U.S. Pat. No. 7,311,526—Magnetic connector for electronic device
U.S. Pat. No. 5,860,827—Plug securing device
U.S. Pat. No. 7,452,233—Plug connection securing device
U.S. Pat. No. 4,178,056—Electric plug with novel cable securing means
U.S. Pat. No. 4,957,450—Electrical cord plug and socket retainer
U.S. Pat. No. 7,470,141—Power cord securing device
U.S. Pat. No. 6,592,392—Device for securing plug to a socket
U.S. Pat. No. 6,099,338—Securing means for blades of electrical plug
U.S. Pat. No. 3,287,920—Device for securing a plug within an infusion hole
U.S. Pat. No. 6,817,076—Securing plug in over-sized holes
U.S. Pat. No. 5,834,920—Holder for securing a recharge plug in a cellular telephone stand

### BRIEF DESCRIPTION OF THE DRAWINGS

FIG. 1 is a perspective view of the preferred embodiment of the present invention;

FIG. 2 is an exploded view of the preferred embodiment of the present invention;

FIG. 3 is a sectional view of Section A-A of FIG. 1;

FIG. 4 is a sectional view of Section B-B of FIG. 2;

FIG. 5 is an alternate embodiment of the present invention;

FIG. 6 is a sectional view of an alternate embodiment of the present invention; and

FIG. 7 illustrates the ability of a plug and socket to disconnect, specifically within an embodiment of prior art U.S. Pat. No. 7,311,526.

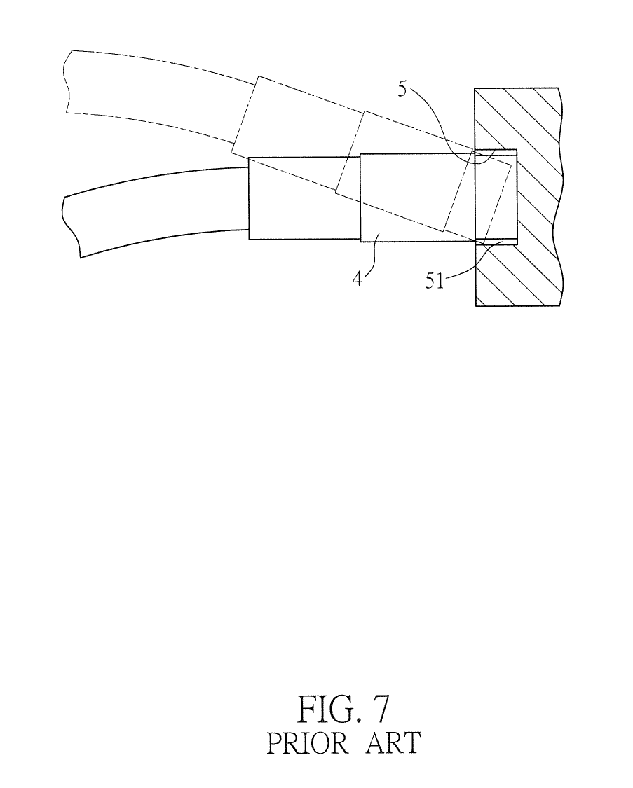

The illustrated configurations of plugs and sockets are susceptible to various modifications and alternative geometries. The figures and written description are not intended to limit the scope of the invention in any manner, only to illustrate the concepts to a person skilled in the art.

### DETAILED DESCRIPTION OF THE INVENTION

The present invention will become clearer in light of the following detailed description of an illustrative embodiment of this invention described in connection with the drawings. It is intended that the embodiments and drawings disclosed herein are considered illustrative rather than restrictive.

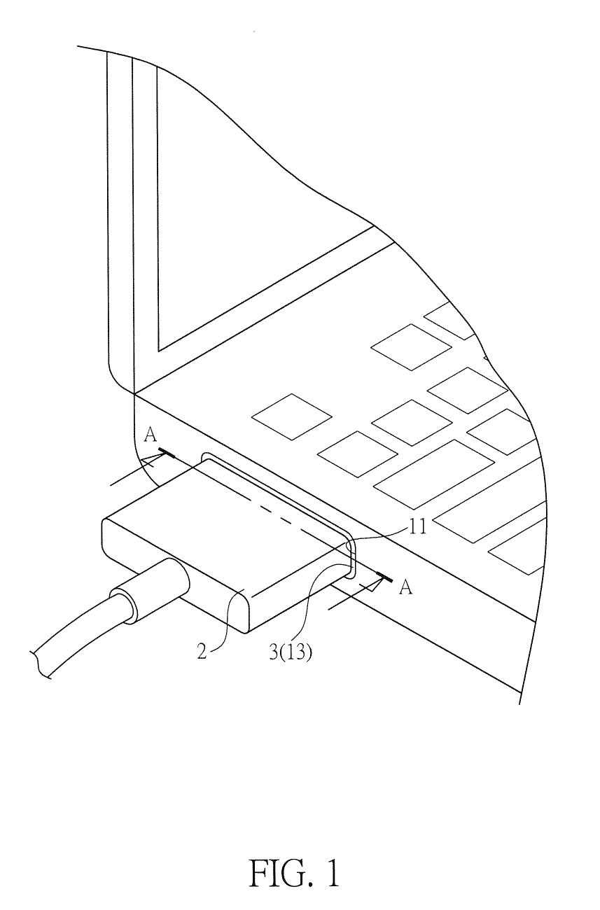

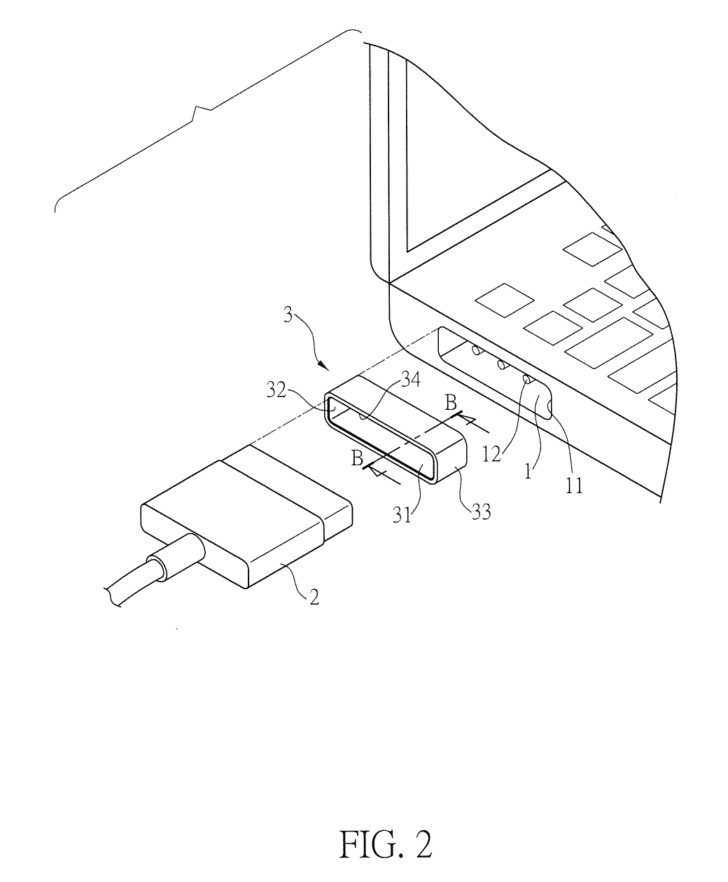

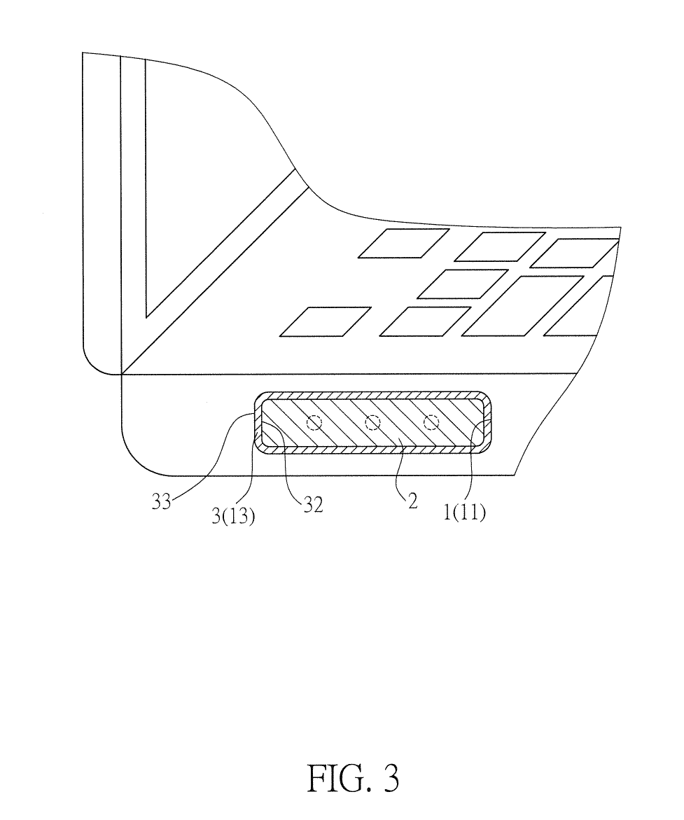

With reference to FIGS. 1 and 2 for a retention device for plugs according to the preferred embodiment of the present invention, the device 3 is applied to a socket 1 of an electronic device and a plug 2 of the socket 1. In this preferred embodiment, a portable computer is used for example, and the socket 1 is provided for attaching an electrical cable plug 2 to connect an external power supply adapter, wherein the socket 1 has an inner peripheral wall 11 and an electric power connecting portion 12, and the plug 2 is smaller than the socket 1, such that when the plug 2 is plugged into the socket 1 and contacted with the electric power connecting portion 12, an annular gap is formed between the plug 2 and the peripheral wall 11 of the socket 1. In this embodiment, the device 3 acts as a frame inside socket 1 and around plug 2. The device 3 has a channel 31 for passing the plug 2 through the device 3 and plugging the plug 2 into the socket 1. In FIG. 3, the device 3 encloses the periphery of the plug 2 and the device 3 together with the plug 2 are plugged into the socket 1, so that the device 3 fills up the gap 13 to secure the plug 2 in the socket 1.

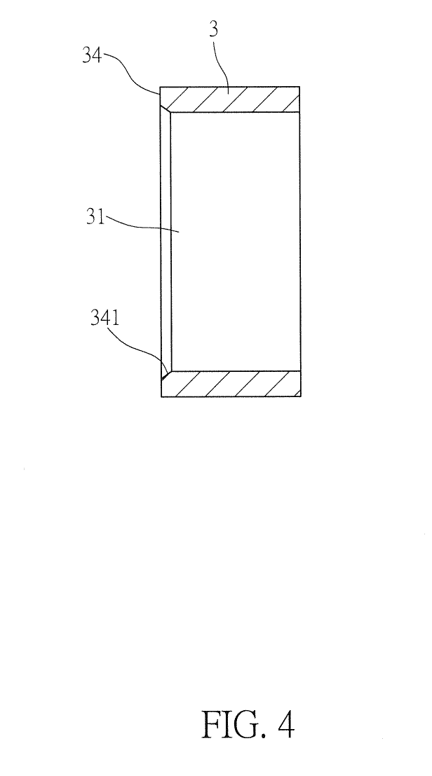

In this preferred embodiment as shown in FIGS. 1, 2, 3, and 4, the device 3 has a channel 31 enclosed therein, and the device 3 has an internal surface 32 and an external surface 33. The internal surface 32 abuts against the outer peripheral wall of the plug 2 while the external surface 33 abuts against the inner peripheral wall 11 of the socket 1 to secure the plug 2 in the socket 1 and prevent the plug 2 from falling out from the socket 1. In addition, the device 3 has an edge 34 formed at an end facing the exterior of the socket 1 as shown in FIG. 4, and a chamfer 341 formed at the internal periphery of the edge 34 providing easier insertion of the plug 2 into the channel 31. In alternate embodiments, the chamfer 341 may be added to the internal periphery of the opposite edge to allow the device bi-directional.

In this preferred embodiment as shown in FIGS. 1, 2, 3, and 4, the device 3 is a closed frame enclosing the channel 31 completely, so that the gap 13 between the plug 2 and the socket 1 is reduced to secure the plug 2 in the socket 1.

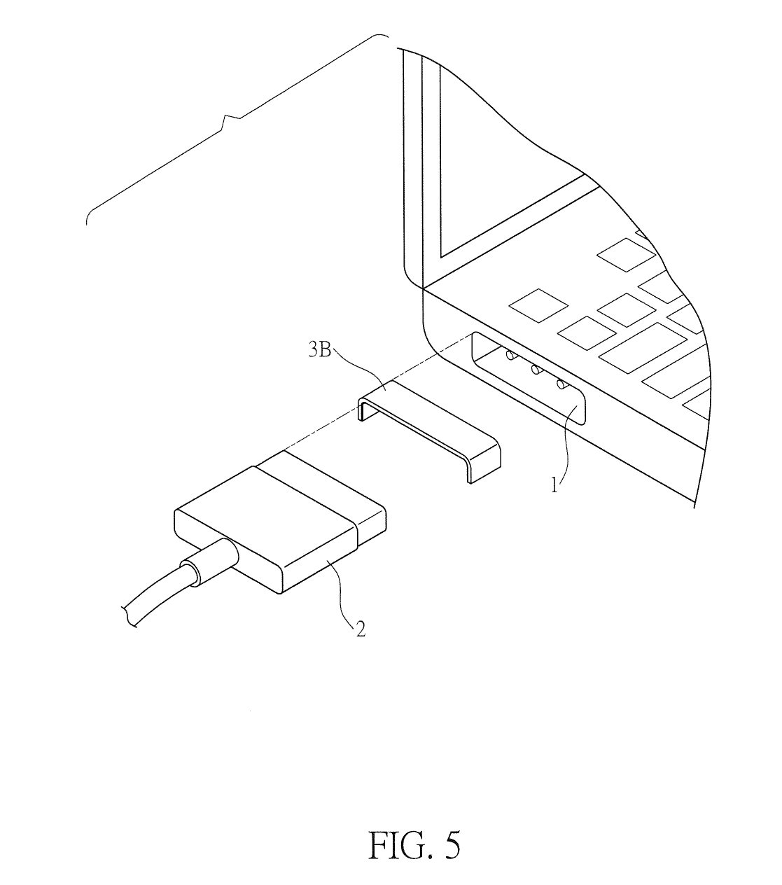

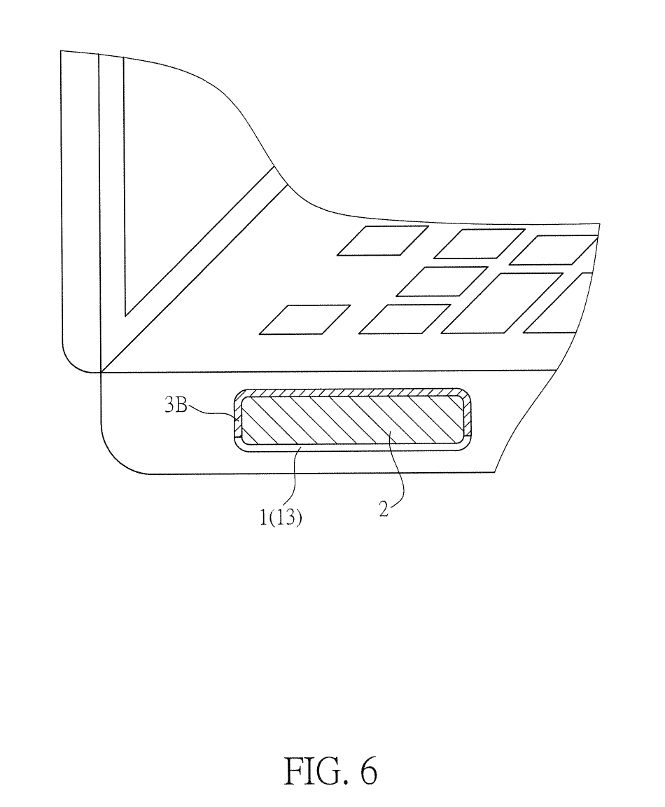

The second preferred embodiment of the present invention is shown in FIGS. 5 and 6, the difference between this preferred embodiment and the first preferred embodiment is the use of an open frame that only partially encloses the channel. In this preferred embodiment, the frame 3B is n-shaped, and the three sidewalls of the frame 3B as shown in FIG. 6 abut against the periphery of the plug 2, and the frame 3B together with the plug 2 are plugged into the socket 1, so that the frame 3B can decrease the gap 13 between the plug 2 and the socket 1 to achieve the effect of securing the plug 2.

In both embodiments described above, the device can be contain a material, usually ferrous in composition, attracted to a magnet, especially when used in conjunction with a magnetic connector as described in prior art U.S. Pat. No. 7,311,526. In FIG. 3, the socket 1 is magnetic. When the device 3 is installed in socket 1, it becomes temporarily magnetic while in contact with socket 1. The magnetic attraction between socket 1 and the said material of device 3 serves to securely retain device 3 inside socket 1.

Secondarily, the ability of device 3, as shown in FIG. 3, to become temporarily magnetic while in contact with said magnetic socket and while inside socket 1 acts to extend the magnetic field further around plug 2, therefore improving the strength of plug retention. Furthermore, in cases where peripheral wall 11 is non-ferrous or non-magnetic, the temporary magnetism of device 3 extends the magnetic reach of socket 1 further along peripheral wall 11, reducing the force required for insertion of plug 2 into socket 1, and improving retention of plug 2 within socket 1.

What is claimed is:

1. A device for retaining a plug within a socket, comprising a frame to be placed between said plug and said socket, with internal dimensions larger than said plug and external dimensions smaller than said socket, positioned such that said frame's internal surface abuts said plug's outer peripheral wall and said frame's external surface abuts said socket's inner peripheral wall, whereby the retention of said plug within said socket is improved.

2. The device of claim 1, wherein said improved plug retention is achieved by said frame sufficiently reducing the annular gap between said plug's outer peripheral wall and said socket's inner peripheral wall.

3. The device of claim 2, wherein said improved plug retention is achieved by said frame reducing vertical movement of said plug within said socket.

4. The device of claim 1, wherein said socket contains a magnetic element and said magnetic element emanates a magnetic field within said socket, whereby said plug is retained in said socket by the magnetic attractive force between said plug and said magnetic field.

5. The device of claim 1, wherein said frame is permanently affixed to said plug or to said socket.

6. The device of claim 1, wherein said frame is removable and said frame is temporarily retained on said plug.

7. The device of claim 1, wherein said frame is removable and said frame is temporarily retained within said socket.

8. The device of claim 1, wherein said frame is removable, said frame contains a ferrous material, said socket contains a magnetic element, and said magnetic element emanates a magnetic field, whereby said frame is retained within said socket by the magnetic attractive force between said ferrous material and said magnetic field.

9. The device of claim 1, wherein said frame contains ferrous material, said plug contains a magnetic element, and said magnetic element emanates a magnetic field, whereby said frame is retained on said plug by the magnetic attractive force between said ferrous material and said magnetic field.

10. The device of claim 1, wherein said frame contains ferrous material and abuts a magnetic element inside said socket, thereby becoming temporarily magnetic and extending the magnetic field of said magnetic element along said inner peripheral wall of said socket.

11. The device of claim 1, wherein said frame is fully enclosed.

12. The device of claim 1, wherein said frame is partially enclosed.

13. The device of claim 1, wherein said frame is rectangular in shape.

14. The device of claim 1, wherein said frame is circular in shape.

15. The device of claim 1, wherein said frame has one of more chamfered internal edges.

16. The device of claim 1, wherein said frame has one or more chamfered external edges.

17. The device of claim 1, wherein said plug and socket contain electrically conductive elements.

18. A method of improving the retention of an electrical plug within an electrical socket by introducing a frame between said plug's outer peripheral wall and said socket's inner peripheral wall, said frame reducing the annular gap between said plug's outer peripheral wall and said socket's inner peripheral wall, whereby the retention of said plug within said socket is improved.

19. The method of claim 18, wherein said frame is temporarily retained on said plug or within said socket.

20. The method of claim 18, wherein said frame contains ferrous material, said socket contains a magnetic element, and said magnetic element emanates a magnetic field, whereby said frame is retained within said socket by the attractive force between said magnetic field and said ferrous material.
